(19) United States
(12) Patent Application Publication
(10) Pub. No.: US 2014/0226578 A1
(43) Pub. Date: Aug. 14, 2014

(54) METHOD AND DEVICE FOR CONTROLLING UPLINK POWER

(71) Applicants: Xudong Zhu, Shanghai (CN); Yubo Yang, Shanghai (CN); Jin Liu, Shanghai (CN); Peng Shang, Shanghai (CN)

(72) Inventors: Xudong Zhu, Shanghai (CN); Yubo Yang, Shanghai (CN); Jin Liu, Shanghai (CN); Peng Shang, Shanghai (CN)

(73) Assignee: ALCATEL LUCENT, Paris (FR)

(21) Appl. No.: 14/111,856

(22) PCT Filed: Mar. 30, 2012
(86) PCT No.: PCT/IB12/00904

§ 371 Date: Oct. 15, 2013

(30) Foreign Application Priority Data
Apr. 15, 2011 (CN) 201110095595.X

(51) Int. Cl. H04W 52/24; H04B 7/02

(52) U.S. Cl. CPC H04W 52/242; H04B 7/024
USPC 370/329

(57) ABSTRACT

The present invention proposes a method and device for controlling uplink power. A central processing unit firstly determines a path loss generation mode for a user equipment according to a predetermined rule and then transmits an instruction to the user equipment, the instruction including the determined path loss generation mode so that the user equipment determines uplink power of fee user equipment according to the path loss generation mode. A user equipment acquires an instruction from a central processing unit to indicate a path loss generation mode of the user equipment, then determines a path loss of the user equipment according to the path loss generation mode indicated by the central processing unit, and then acquires uplink transmission power of the user equipment according to the determined path loss of the user equipment. With the inventive solution, a central processing unit may configure a path loss generation mode flexibly for a user equipment to accommodate different uplink CoMP scenarios and thereby achieve better CoMP performance.

### FIELD OF THE INVENTION

The present invention relates to a coordinated multipoint based radio communication network and in particular to a method and device for controlling uplink power in a coordinated multipoint based radio communication network.

### BACKGROUND OF THE INVENTION

As well known, the performance of a cellular network may be further improved with Coordinated Multi-Point (CoMP). Uplink coordinated multipoint has been widely studied in the Third Generation Partnership Project (3GPP) and exhibited a significant performance gain and an influence upon existing 3GPP standardization.

In the 3GPP, traditional Fractional Power Control (FPC) is performed to compensate for a Path Loss (PL) to a serving cell (i.e., a serving base station), and transmission power of a user at the cell edge is reduced to reduce inter-cell interference to adjacent cells. However the FPC solution to fractional compensation for a path loss between a serving base station and a user equipment may not be applicable in a situation where a signal of the user equipment may be received at a plurality of points including a serving base station and at least one cooperative base station. A plurality of reception points may exist in uplink CoMP and at least a part of inter-cell interference signals in the existing FPC solution may be taken as a useful signal, therefore the FPC solution to compensation for a path loss to a serving base station will not be applicable to the uplink CoMP scenario any longer.

### SUMMARY OF THE INVENTION

Only the path loss between a user equipment and a serving base station is taken into account in the existing solution to acquisition of uplink power. A principle of the fractional power control solution lies in that a path loss compensation coefficient α is configured and appropriate transmission power of a user equipment at the cell edge is calculated so as to reduce interference of a user at the cell edge to an adjacent cell while ensuring normal uplink data transmission between the user equipment at the cell edge and a serving base station. That is, a signal of the user equipment to the adjacent cell is treated as interference.

However a signal of a user equipment to an adjacent cell may also be taken as a useful signal according to different inter-cell cooperation modes in the uplink CoMP solution. Furthermore there may be different path losses between a user equipment and different base stations (including a serving base station and a cooperative base station) due to different propagation paths and scattering environments. Therefore the existing approaches for determining a path loss may not be applicable to the uplink CoMP scenario. In view of this, the invention proposes an improved solution to uplink power control.

According to a first aspect of the invention, there is provided a method for controlling uplink power in a coordinated multipoint based user equipment, the method including the steps of: acquiring an instruction from a central processing unit to indicate a path loss generation mode of the user equipment; determining a path loss of the user equipment according to the path loss generation mode indicated by the central processing unit; and acquiring uplink transmission power of the user equipment according to the determined path loss of the user equipment.

According to a second aspect of the invention, there is provided a method for assisting a user equipment in controlling uplink power in a coordinated multipoint based central processing unit, the method including the steps of: I. determining a path generation mode for the user equipment according to a predetermined rule; and II. transmitting an instruction to the user equipment, the instruction including the determined path generation mode so that the user equipment determines uplink power of the user equipment according to the path generation mode.

According to a third aspect of the invention, there is provided a first device for controlling uplink power in a coordinated multipoint based user equipment, the first device including: a first acquiring means for acquiring an instruction from a central processing unit to indicate a path loss generation mode of the user equipment; a first determining means for determining a path loss of the user equipment according to the path loss generation mode indicated by the central processing unit; and a second acquiring means for acquiring uplink transmission power of the user equipment according to the determined path loss of the user equipment.

According to a fourth aspect of the invention, there is provided a second device for assisting a user equipment in controlling uplink power in a coordinated multipoint based central processing unit, the second device including: a second determining means for determining a path generation mode for the user equipment according to a predetermined rule; and transmitting means for transmitting an instruction to the user equipment, the instruction including the determined path generation mode so that the user equipment determines uplink power of the user equipment according to the path generation mode.

With the solutions of the invention, a central processing unit may configure a path loss generation mode flexibly for a user equipment to accommodate different uplink CoMP scenarios and thereby achieve better CoMP performance.

### BRIEF DESCRIPTION OF THE DRAWINGS

Other objects, features and advantages of the invention will become more apparent and prominent upon reading the following description of non-limiting embodiments with reference to the drawings in which:

FIG. 1 illustrates a schematic diagram of a network topology according to an embodiment of the invention;

FIG. 2 illustrates a flow chart of a system method according to an embodiment of the invention;

FIG. 3 illustrates a block diagram of a device according to an embodiment of the invention;

FIG. 4 illustrates a simulation diagram according to an embodiment of the invention; and

FIG. 5 illustrates a simulation diagram according to another embodiment of the invention.

In the drawings, identical or like reference numerals identify identical or like step features/means (modules).

### DETAILED DESCRIPTION OF THE INVENTION

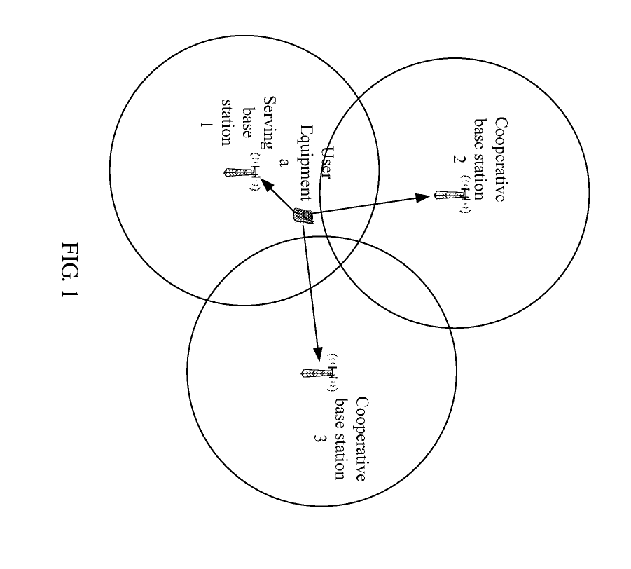

FIG. 1 illustrates a network architecture diagram according to an embodiment of the invention, where a serving base station 1 and two cooperative base stations 2 and 3 receive jointly an uplink signal from a user equipment a. Particularly the serving base station 1 and the cooperative base stations 2 and 3 compose a cooperative cell set. Only two cooperative base stations 2 and 3 are illustrated in FIG. 1 for the sake of convenience. Those skilled in the art may appreciate that the number of cooperative base stations may be one or more but will not be limited to two as listed here. Firstly a central processing unit being integrated in the serving base station 1 will be described hereinafter by way of an example.

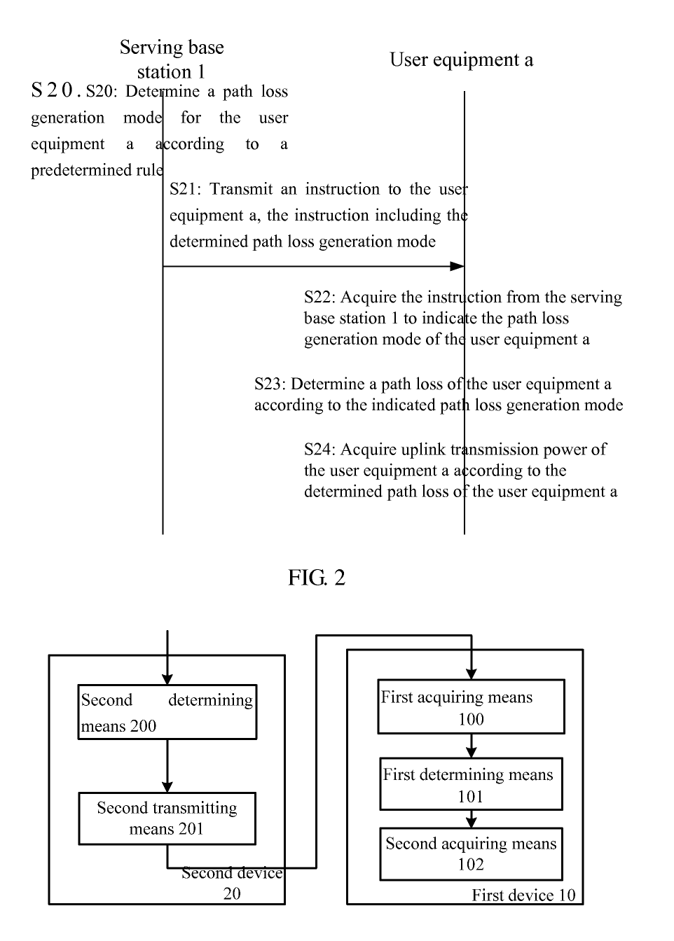

FIG. 2 illustrates a flow chart of a system method according to an embodiment of the invention.

Firstly in the step S20, the serving base station 1 determines a path loss generation mode for the user equipment a according to a predetermined rule.

The serving base station 1 may select one of the following six modes for the user equipment a to determine a path loss.

In an option a, the path loss generation mode is indicated that the user equipment a takes the average of path losses between the user equipment a and the respective base stations, i.e., the linear average of the path loss between the user equipment a and the serving base station 1 and the path losses between the user equipment a and the cooperative base stations 2 and 3, as the determined path loss. The determined path loss is expressed in the following formula:

PL=avg{PL₁,PL₂, . . . ,PL_{N}}.

Where, for example, PL₁ represents the path loss between the serving base station 1 and the user equipment a, and N=3 in this embodiment, that is, PL₂ and PL₃ represent the path losses between the user equipment a and the cooperative base stations 2 and 3 respectively. Those skilled in the art may appreciate that N−1 represents the number of cooperative base stations jointly with which the serving base station 1 communicates with the user equipment a, and in a practical application, the number of cooperative base stations will not be limited to two as listed here in this embodiment.

In an option b, the path loss generation mode is indicated that the user equipment a takes the minimum of the path losses between the user equipment a and the respective base stations, i.e., the minimum of the path loss between the user equipment a and the serving base station 1 and the path losses between the user equipment a and the cooperative base stations 2 and 3, as the determined path loss. The determined path loss is expressed in the following formula:

PL=min{PL₁,PL₂, . . . ,PL_{N}}.

Where, for example, PL₁ represents the path loss between the serving base station 1 and the user equipment a, and N=3 in this embodiment, that is, PL₂ and PL₃ represent the path losses between the user equipment a and the cooperative base stations 2 and 3 respectively. Those skilled in the art may appreciate that N−1 represents the number of cooperative base stations jointly with which the serving base station 1 communicates with the user equipment a, and in a practical application, the number of cooperative base stations will not be limited to two as listed here in this embodiment.

In an option c, the path loss generation mode is indicated that the user equipment a takes the maximum of the path losses between the user equipment a and the respective base stations, i.e., the maximum of the path loss between the user equipment a and the serving base station 1 and the path losses between the user equipment a and the cooperative base stations 2 and 3, as the determined path loss. The determined path loss is expressed in the following formula:

PL=max{PL₁,PL₂, . . . ,PL_{N}}.

Where, for example, PL₁ represents the path loss between the serving base station 1 and the user equipment a, and N=3 in this embodiment, that is, PL₂ and PL₃ represent the path losses between the user equipment a and the cooperative base stations 2 and 3 respectively. Those skilled in the art may appreciate that N−1 represents the number of cooperative base stations jointly with which the serving base station 1 communicates with the user equipment a, and in a practical application, the number of cooperative base stations will not be limited to two as listed here in this embodiment.

In an option d, the path loss generation mode is indicated that the user equipment a takes the path loss between the user equipment a and the serving base station 1 as the determined path loss. The determined path loss is expressed in the following formula:

PL=PL_{serving}.

Where PL_{serving} represents the path loss between the user equipment a and the serving base station 1.

In an option e, the path loss generation mode is indicated that the user equipment a takes the reciprocal of the sum of the reciprocal of the path loss between the user equipment a and the serving base station 1 and the reciprocals of the path losses between the user equipment a and the cooperative base stations 2 and 3 as the determined path loss. The determined path loss is equivalent to an equivalence of the path losses between the user equipment a and the respective base stations. The determined path loss is expressed in the following formula:

$$PL = \frac{1}{\frac{1}{{PL}_{1}} + \frac{1}{{PL}_{2}} + … + \frac{1}{{PL}_{N}}} .$$

Where, for example, PL₁ represents the path loss between the serving base station 1 and the user equipment a, and N=3 in this embodiment, that is, PL₂ and PL₃ represent the path losses between the user equipment a and the cooperative base stations 2 and 3 respectively. Those skilled in the art may appreciate that N−1 represents the number of cooperative base stations jointly with which the serving base station 1 communicates with the user equipment a, and in a practical application, the number of cooperative base stations will not be limited to two as listed here in this embodiment.

In an option f, the path loss generation mode is indicated that the user equipment a takes a path loss between the user equipment a and a specified one of the cooperative base stations as the determined path loss. In an embodiment, the serving base station 1 may specify the path loss between the cooperative base station 2 and the user equipment a is taken as the determined path loss. In the case that the path loss between a cooperative base station and the user equipment is taken as the determined path loss, the serving base station 1 will further provide the user equipment a with the identifier of the specified cooperative base station. In an embodiment, the user equipment a is provided with the ID of the cooperative base station 2 in the case that the path loss between the cooperative base station 2 and the user equipment a is taken as the determined path loss.

The serving base station 1 may determine the path generation mode for the user equipment a according to a cooperation mode between the serving base station 1 and the cooperative base stations 2 and 3. Particularly, for example, the linear average mode, the equivalence mode or the maximum path loss mode may be applied when the serving base station 1 and the cooperative base stations 2 and 3 receive jointly a signal from the user equipment a. On the contrary, the serving base station 1 selects the option b of taking the minimum of the path losses as the determined path loss when a signal from the user equipment a is treated as interference to the cooperative base stations 2 and 3. Of course, a CoMP scenario in a practical system is more complex than the foregoing examples, and the examples here are merely illustrative. Some other parameters may be very likely to be taken into account in a practical application. Furthermore the serving base station 1 may also determine the cooperation mode more flexibly. For example, it is determined that only the cooperative base station 2 receives uplink data from the user equipment a, and therefore the serving base station 1 will instruct the user equipment a to measure its path loss to the cooperative base station 2, for example, as depicted in the option f.

Then in the step S21, the serving base station 1 transmits an instruction to the user equipment a, the instruction including the determined path loss generation mode, so that the user equipment a determines uplink power of the user equipment according to the path loss generation mode.

Then in the step S22, the user equipment a acquires the instruction from the serving base station 1 to indicate the path loss generation mode of the user equipment a.

Then in the step S23, the user equipment a determines the path loss of the user equipment a according to the path loss generation mode indicated from the serving base station 1.

A downlink path loss is acquired by the user equipment a according to the difference between Reference Signal Received Power (RSRP) and known downlink Reference Signal (RS) transmission power (broadcast from the serving base station 1).

When the instruction received by the user equipment a includes such an indicator that the user equipment a determines the path loss according to the option d, the user equipment a will simply acquire the path loss to the serving base station 1, that is, the user equipment a acquires the determined path loss in the formula of PL=PL_{serving}.

When the instruction received by the user equipment a includes such an indicator of the serving base station 1 that the user equipment a determines the path loss in any one of the options a, b, c and e, the user equipment a will further need to measure the path losses to the respective cooperative base stations and acquire the determined path loss in the corresponding formula.

In the case of a-c and e, all of the serving base station 1 and the cooperative base stations 2 and 3 receiving uplink data from the user equipment will be described by way of example. Firstly the user equipment a will measure its path losses respectively to the cooperative base station 2 and the cooperative base station 3, i.e., PL₂ and PL₃, and then:

In the case of a, the user equipment a calculates the determined path loss according to the formula of PL=avg{PL₁, PL₂, PL₃}.

In the case of b, the user equipment a calculates the determined path loss according to the formula of PL=min {PL₁, PL₂, PL₃}.

In the case of c, the user equipment a calculates the determined path loss according to the formula of PL=max {PL₁, PL₂, PL₃}.

In the case of e, the user equipment a calculates the determined path loss according to the formula of

$$PL = \frac{1}{\frac{1}{{PL}_{1}} + \frac{1}{{PL}_{2}} + \frac{1}{{PL}_{3}}} .$$

In another example, when the instruction received by the user equipment a includes such an indicator of the serving base station 1 that the user equipment a determines the path loss in the option f, the instruction further includes the identifier of a cooperative base station specified by the serving base station 1, so that the user equipment a acquires its path loss to the cooperative base station identified by the identifier. In an embodiment, for example, when the instruction includes such an indicator that the serving base station 1 specifies that the user equipment a determines final transmission power according to its path loss to the cooperative base station 2, that is, includes the identifier of the cooperative base station 2, the user equipment a measures its path loss to the cooperative base station 2 and thereby acquires the determined path loss.

Then in the step S24, the user equipment a further acquires uplink transmission power of the user equipment a according to the determined path loss of the user equipment a. Particularly the user equipment calculates the uplink transmission power of the user equipment a according to the formula of P(i)=min {P_{MAX},10 log₁₀(M(i))+P_{O}(j)+α(j)·PL+Δ_{TF}(i)+f(i)}, where P_{MAX} represents the maximum transmission power of the user equipment a, M(i) represents the number of uplink resource blocks allocated to the user equipment a, P_{O}(j) represents a cell specific or user equipment specific reference power parameter, α(j) represents a cell specific compensation coefficient, PL represents the abovementioned determined path loss, and Δ_{TF}(i)+f(i) represents a dynamic offset.

The foregoing formula in which the uplink transmission power of the user equipment a is calculated is applicable to transmission power over an uplink channel of PUSCH, that is, applicable to uplink transmission power of data. The foregoing formula is modified by adding the suffix of PUSCH so that the foregoing power control formula may be represented as

P_{PUSCH}(i)=min{P_{CMAX},10 log₁₀(M_{PUSCH}(i))+P_{O}_{_{—}}_{PUSCH}(j)+α(j)·PL+Δ_{TF}(i)+f(i)}.

Where P_{CMAX} represents the maximum transmission power of the user equipment a and is related to a power level of the UE;

M_{PUSCH(i)} represents the size of PUSCH physical resource block, allocated to the user equipment, in the i^{th} sub-frame;

P_{O}_{_{—}}_{PUSCH(j)} represents two parameters of P_{O}_{_{—}}ₙₒₘᵢₙₐₗ_{_{—}}_{PUSCH}(j) and P_{O}_{_{—}}_{UE}_{_{—}}_{PUSCH}(j), where P_{O}_{_{—}}ₙₒₘᵢₙₐₗ_{_{—}}_{PUSCH}(j) represents a power reference value which is set dependent upon the size of cell and provided by upper layer signaling for j=0 and 1, and P_{O}_{_{—}}_{UE}_{_{—}}_{PUSCH}(j) represents a user equipment specific reference value determined by the type and the location of the user equipment and provided by upper layer signaling for j=0 and 1. The value of j is {0, 1, 2} including three values taken dependent upon different uplink services of the user equipment. The value of j is 0 with new transmission or retransmission over a semi-persistently scheduled resource, 1 with new transmission or retransmission over a dynamically scheduled resource, or 2 with transmission of random response information from the UE over the PUSCH. P_{O}_{_{—}}_{UE}_{_{—}}_{PUSCH}(2)=0 and P_{O}_{_{—}}ₙₒₘᵢₙₐₗ_{_{—}}_{PUSCH}(2)=P_{O}_{_{—}}_{PRE}+Δ_{PREAMBLE}_{_{—}}_{Msg3} where the parameters of PREAMBLE_INITIAL_RECEIVED_TARGET_POWER (P_{O}_{_{—}}_{PRE}) and Δ_{PREAMBLE}_{_{—}}_{Msg3} are indicated by upper layer signaling.

α(j) represents a fractional power compensation factor, and αε{0, 0.4, 0.5, 0.6, 0.7, 0.8, 0.9, 1} for j=0 or 1, and this parameter is a cell specific parameter and represented in 3 bits. α(j)=1 for j=2.

Δ_{TF}(i)=10 log₁₀((2^{MPR·K}^{_{S}}−1)β_{offset}^{PUSCH}) for K_{S}=1.25 and ΔTF(i)=0 for K_{S}=0, where K_{S} is provided in a user equipment specific parameter of deltaMCS-Enabled from an upper layer.

Reference may be made to the 3GPP TS36213.870 for details of the foregoing and other parameters in the formula, and a repeated description thereof will be omitted here.

For a Sounding Reference Signal (SRS), an extra semi-static offset configured by Radio Resource Control (RRC) upper signaling is added to the formula in which uplink transmission power over a PUSCH is calculated.

Furthermore the inventive solution to determination of a path loss may also be equally applicable to calculation of transmission power over a PUCCH, that is, applicable to uplink transmission power of control signaling. The user equipment a may acquire transmission power over a physical uplink control channel according to the formula of

P_{PUCCH}(i)=min{P_{CMAX},P₀_{_{—}}_{PUCCH}+PL+h(n_{CQI},n_{HARQ})+Δ_{F}_{_{—}}_{PUCCH}(F)+g(i)}.

Where P_{CMAX} represents the maximum transmission power of the user equipment a, which is related to a power level of the UE;

h(n_{CQI},n_{HARQ}) represents a power offset calculated from the numbers of information bits in a CQI and an HARQ in the PUCCH; and P_{O}_{_{—}}_{PUCCH} includes two parameters of P_{O}_{_{—}}ₙₒₘᵢₙₐₗ_{_{—}}_{PUCCH} and P_{O}_{_{—}}_{UE}_{_{—}}_{PUCCH}, where P_{O}_{_{—}}_{NOMINAL}_{_{—}}_{PUCCH} is a cell specific parameter provided by upper layer, and P_{O}_{_{—}}_{UE}_{_{—}}_{PUCCH} is a user equipment specific parameter provided from an upper layer.

Δ_{F}_{_{—}}_{PUCCH}(F) is provided by upper layer.

Reference may be made to the 3GPP TS36213.870 for details of the foregoing and other parameters in the formula, and a repeated description thereof will be omitted here.

As compared with power control over the PUSCH, full compensation is adopted for power control over the PUCCH, that is, α is constantly equal to 1, thus equals to eliminating the parameter of fractional power compensation.

Since information generally carried by the PUCCH includes CQI and HARQ information fed back from the user equipment and there are six transmission modes (the formats 1, 1a, 1b, 2, 2a and 2b) with inconsistent lengths and different amounts of carried information, power control over the PUCCH is designed primarily for the different transmission modes.

The central processing unit being integrated in the serving base station 1 has been described by way of an example in the foregoing respective embodiments. Those skilled in the art shall appreciate that the central processing unit may alternatively be separate from the serving base station 1, and in this modified embodiment, the operating step S20 performed by the serving base station 1 is performed by the central processing unit.

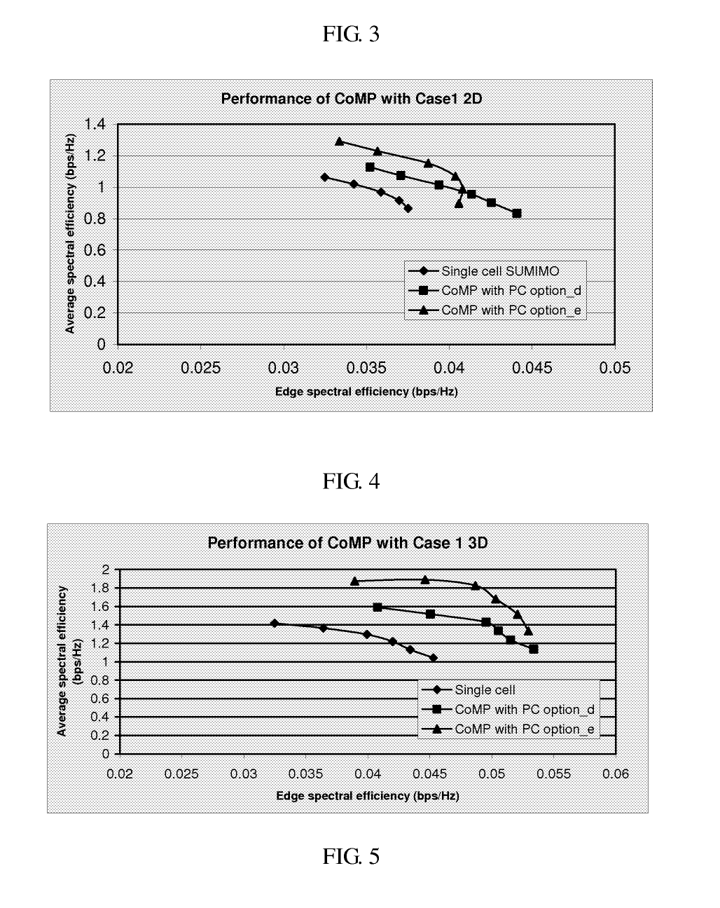

The invention has been described above from the perspective of a flow of a system method and will be described below from the perspective of a block diagram of a system. FIG. 3 illustrates a block diagram of a device according to an embodiment of the invention, where a first device 10 is located in the user equipment a and a second device 20 is located in the central processing unit. Those skilled in the art may appreciate that the central processing unit may be located in the serving base station 1 or in another network entity separate from the serving base station 1.

The first device 10 includes first acquiring means 100, first determining means 101 and second acquiring means 102. The second device 20 includes second determining means 200 and transmitting means 201.

Firstly the second determining means 200 determines a path loss generation mode for a user equipment according to a predetermined rule.

Then the transmitting means 201 transmits an instruction to the user equipment, the instruction including the determined path generation mode so that the user equipment calculates uplink power of the user equipment according to the path generation mode. The instruction includes any one of the following options:

a. Indicating the path loss generation mode that the user equipment takes the linear average of path losses between the user equipment and a serving base station and between the user equipment and at least one cooperative base station as a determined path loss;

b. Indicating the path loss generation mode that the user equipment takes the minimum of the path losses between the user equipment and the serving base station and between the user equipment and the at least one cooperative base station as the determined path loss;

c. Indicating the path loss generation mode that the user equipment takes the maximum of the path losses between the user equipment and the serving base station and between the user equipment and at least one cooperative base station as the determined path loss;

d. Indicating the path loss generation mode that the user equipment takes the path loss between the user equipment and the serving base station as the determined path loss;

e. Indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and

f. Indicating the path loss generation mode that the user equipment takes a path loss between the user equipment and a specified one of the at least one cooperative base station as the determined path loss.

Then the first acquiring means 100 acquires the instruction from the central processing unit to indicate the path loss generation mode of the user equipment.

Then the first determining means 101 determines a path loss of the user equipment according to the path loss generation mode indicated by the central processing unit.

Then the acquiring means is for acquiring uplink transmission power of the user equipment according to the determined path loss of the user equipment.

In an embodiment, when the user equipment performs uplink communication cooperatively with a serving base station and at least one of at least one cooperative base station, the instruction includes any one of the following options:

a. Indicating the path loss generation mode that the user equipment takes the linear average of path losses between the user equipment and the serving base station and between the user equipment and the at least one cooperative base station as a determined path loss;

b. Indicating the path loss generation mode that the user equipment takes the minimum of the path losses between the user equipment and the serving base station and between the user equipment and the at least one cooperative base station as the determined path loss;

c. Indicating the path loss generation mode that the user equipment takes the maximum of the path losses between the user equipment and the serving base station and between the user equipment and at least one cooperative base station as the determined path loss;

d. Indicating the path loss generation mode that the user equipment takes the path loss between the user equipment and the serving base station as the determined path loss;

e. Indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and

f. Indicating the path loss generation mode that the user equipment takes a path loss between the user equipment and a specified one of the at least one cooperative base station as the determined path loss.

When the instruction includes any one of a, b, c or e, the first device further includes measuring means (not illustrated) for measuring the path loss between the user equipment and the at least one cooperative base station.

When the instruction includes the option f, the instruction further includes the identifier of a specified cooperative base station.

The measuring means is further for measuring the path loss between the user equipment and the specified cooperative base station indicated by the identifier.

The invention has been detailed above from the perspective of a system method and a block diagram of a device, and advantages of the inventive solutions will be further described in a simulation result.

Simulation Result

Table 1 below depicts simulation parameters of 3GPP uplink CoMP.

TABLE 1

| Parameter | | Value |
|---|---|---|
| CF | | 2 GHz |
| Inter-Site Distance | | 500 (meters) |
| Bandwidth | | 10 Mhz |
| Multiplex Mode | | Frequency Division Duplex (FDD) |
| Network Synchronization | | Synchronous |
| Uplink Transmission | | 1 × 2 SIMO |
| Scheme | | |
| Uplink Scheduler | | Proportion Fair Scheduler |
| Uplink Power Control | | Fractional power control with the path loss |
| | | difference between a serving cell and the |
| | | strongest adjacent cell |
| Uplink HARQ | | Maximum four transmissions, Chase |
| | | Combining |
| Antenna Pattern | | downtilt. the values 15 degrees for 3 GPP |
| | | case 1 3D, 0 for case 1 2D |
| Channel Model | | Spatial Channel Model (SCM) with high |
| | | spread (TR 25.996) |
| UE Maximum | | 24 dBm |
| Transmission power | | |
| UE Speed | | 3 km/h |
| Base Station Antenna | | Co-polarized antennas separated by four |
| Configuration | | wavelengths |
| Cell Layout | | Hexagon grid, nineteen cell sites each |
| | | with three sectors wrap round |
| Distance Related Path Loss | | L = 128.1 + 37.6log10(.R), R in kilometers |
| Penetration Loss | | 20 dB |
| Shadow Fading | | 8 dB |
| Correlation distance of | | 50 m |
| Shadowing | | |
| Shadowing | Inter-Cell | 0.5 |
| correlation | Inter-Sector | 1.0 |

| | |
|---|---|
| UE traffic | Full Buffer |
| User Distribution | Randomly and uniformly distributed in |
| | an area. The minimum distance to a site |
| | is 35 m, Re-drop users within minimum |
| | distance |
| BS Noise Figure | 5 dB |
| BS Feeder Loss | 2 dB |
| BS Antenna Gain | 17 dBi |
| The Number of UEs | 10 |
| in Each Sector | |

Table 2 below depicts simulation performance with different IoTs for different path losses in the CoMP scenario two, where Jain's Index represents fairness which is the higher the better.

TABLE 2

| | Path Loss | | Average | Edge | Jain's | Average | Edge |
|---|---|---|---|---|---|---|---|
| CoMP | Setting | IoT | Throughput | Throughput | Index | Gain | Gain |
| Scenario 2 | Path loss with | 4.8612 | 1.343643 | 0.052974 | 0.7905 | | |
| | serving cell | | | | | | |
| Scenario 2 | Maximum path | 4.517634688 | 1.542817102 | 0.048374654 | 0.753532613 | 14.82% | −8.68% |
| | loss in sub- | | | | | | |
| | cluster (6 dB) | | | | | | |
| Scenario 2 | Path loss with | 7.7084 | 1.489376 | 0.062457 | 0.8025 | | |
| | serving cell | | | | | | |
| Scenario 2 | Maximum path | 8.031239149 | 1.740076 | 0.061334186 | 0.773681358 | 16.83% | −1.80% |
| | loss in sub- | | | | | | |
| | cluster (6 dB) | | | | | | |
| | targeted IoT 10 | | | | | | |

In order to clarify the advantage of power control performed by configuring different path loss generation modes, the options e and d for a solution to determination of a path loss are compared below respectively in the scenario of 3GPP Case One (a 3GPP defined simulation scenario) 2D and the scenario of 3GPP Case One 3D in FIG. 4 and FIG. 5. FIG. 4 and FIG. 5 illustrate the average throughout of a cell, the throughout at the cell edge (5% Cumulative Distribution Function (CDF)) and the average Interference over Thermal (IoT) of approximately 5 dB. Both FIG. 4 and FIG. 5 illustrate advantageous performance of the average throughout and the edge throughout in uplink CoMP power control in the option e over the performance of the average throughout and the edge throughout in uplink CoMP power control in the option d in most cases, and this advantage is more apparent in FIG. 5, i.e., in the Situation One 3D,

Those ordinarily skilled in the art may appreciate and make other modifications to the disclosed embodiments from upon reading the description, the disclosed teaching and drawings and the appended claims. In the claims, the term “comprise(s)/comprising” will not preclude other elements and steps, and the term “a(an)” will not preclude plural. A component may perform functions of a plurality of technical features recited in the claims in a practical application of the invention. Any reference numeral in the claims shall not be taken as limiting the scope of the invention.

1. A method for controlling uplink power in a coordinated multipoint based user equipment, comprising:
acquiring an instruction from a central processing unit to indicate a path loss generation mode of the user equipment;
determining a path loss of the user equipment according to the path loss generation mode indicated by the central processing unit; and
acquiring uplink transmission power of the user equipment according to the determined path loss of the user equipment.

2. The method according to claim 1, wherein the user equipment performs uplink communication cooperatively with a serving base station and at least one of at least one cooperative base station, and the instruction comprises any one of the following options:
a. indicating the path loss generation mode that the user equipment takes the linear average of path losses between the user equipment and the serving base station and between the user equipment and the at least one cooperative base station as the determined path loss;
b. indicating the path loss generation mode that the user equipment takes the minimum of the path losses between the user equipment and the serving base station and between the user equipment and the at least one cooperative base station as the determined path loss;
c. indicating the path loss generation mode that the user equipment takes the maximum of the path losses between the user equipment and the serving base station and between the user equipment and the at least one cooperative base station as the determined path loss;
d. indicating the path loss generation mode that the user equipment takes the path loss between the user equipment and the serving base station as the determined path loss;
e. indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and
f. indicating the path loss generation mode that the user equipment takes a path loss between the user equipment and a specified one of the at least one cooperative base station as the determined path loss.

3. The method according to claim 2, wherein when the instruction comprises any one of a, b, c or e, the method further comprises measuring the path loss between the user equipment and the at least one cooperative base station before the determining; and when the instruction comprises the option f, the instruction further comprises the identifier of the specified cooperative base station, and the method further comprises measuring the path loss between the user equipment and the specified cooperative base station indicated by the identifier before the determining.

4. The method according to claim 1, wherein the acquiring power further comprises:
determining the uplink transmission power of the user equipment according to the determined path loss of the user equipment and the formula of P(i)=min{P_{MAX}, 10\og₁₀(M(i))+P_{O}(j)+(j)−PL+A_{TF}+f(i)}, wherein P_{MAX} represents the maximum transmission power of the user equipment, M(i) represents the number of uplink resource blocks allocated to the user equipment, P_{Q}(j) represents a cell specific or user equipment specific reference power parameter, (j) represents a cell specific compensation coefficient, PL represents the determined path loss, and A_{TP}(i)+f(i) represents a dynamic offset.

5. The method according to claim 1, wherein the uplink power comprises transmission power over a physical uplink shared channel, transmission power over a physical uplink control channel or transmission power of a sounding reference signal.

6. A method for assisting a user equipment in controlling uplink power in a coordinated multipoint based central processing unit, comprising:
determining a path generation mode for the user equipment according to a predetermined rule; and
transmitting an instruction to the user equipment, the instruction comprising the determined path generation mode so that the user equipment determines uplink power of the user equipment according to the path generation mode.

7. The method according to claim 6, wherein the instruction comprises any one of the following options:
a. indicating the path loss generation mode that the user equipment takes the linear average of path losses between the user equipment and a serving base station and between the user equipment and at least one cooperative base station as a determined path loss;
b. indicating the path loss generation mode that the user equipment takes the minimum of the path losses between the user equipment and the serving base station and between the user equipment and the at least one cooperative base station as the determined path loss;
c. indicating the path loss generation mode that the user equipment takes the maximum of the path losses between the user equipment and the serving base station and between the user equipment and at least one cooperative base station as the determined path loss;
d. indicating the path loss generation mode that the user equipment takes the path loss between the user equipment and the serving base station as the determined path loss;
e. indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and
f. indicating the path loss generation mode that the user equipment takes a path loss between the user equipment and a specified one of the at least one cooperative base station as the determined path loss.

8. The method according to claim 6, wherein the determining comprises:
determining the path generation mode for the user equipment according to a cooperation mode between a serving base station and at least one cooperative base station.

9. The method according to claim 7, wherein when the instruction comprises the option f, the instruction further comprises the identifier of the specified cooperative base station.

10. The method according to claim 6, wherein the central processing unit is integrated in a serving base station or the central processing unit is separate from the serving base station.

11. A first device for controlling uplink power in a coordinated multipoint based user equipment, comprising:
a first acquiring means for acquiring an instruction from a central processing unit to indicate a path loss generation mode of the user equipment;
a first determining means for determining a path loss of the user equipment according to the path loss generation mode indicated by the central processing unit; and
a second acquiring means for acquiring uplink transmission power of the user equipment according to the determined path loss of the user equipment.

12. The first device according to claim 11, wherein the user equipment performs uplink communication cooperatively with a serving base station and at least one of at least one cooperative base station, and the instruction comprises any one of the following options:
a. indicating the path loss generation mode that the user equipment takes the linear average of path losses between the user equipment and the serving base station and between the user equipment and the at least one cooperative base station as the determined path loss;
b. indicating the path loss generation mode that the user equipment takes the minimum of the path losses between the user equipment and the serving base station and between the user equipment and the at least one cooperative base station as the determined path loss;
c. indicating the path loss generation mode that the user equipment takes the maximum of the path losses between the user equipment and the serving base station and between the user equipment and the at least one cooperative base station as the determined path loss;
d. indicating the path loss generation mode that the user equipment to take the path loss between the user equipment and the serving base station as the determined path loss;
e. indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and
f. indicating the path loss generation mode that the user equipment takes a path loss between the user equipment and specified one of the at least one cooperative base station as the determined path loss.

13. The first device according to claim 12, wherein when the instruction comprises any one of a, b, c or e, the first device further comprises:
measuring means for measuring the path loss between the user equipment and the at least one cooperative base station; and
when the instruction comprises the option f, the instruction further comprises the identifier of the specified cooperative base station, and
the measuring means is further for measuring the path loss between the user equipment and the specified cooperative base station indicated by the identifier.

14. A second device for assisting a user equipment in controlling uplink power in a coordinated multipoint based central processing unit, comprising:
a second determining means for determining a path generation mode for the user equipment according to a predetermined rule; and
transmitting means for transmitting an instruction to the user equipment, the instruction comprising the determined path generation mode so that the user equipment determines uplink power of the user equipment according to the path generation mode.

15. The second device according to claim 14, wherein the instruction comprises any one of the following options:
a. indicating the path loss generation mode that the user equipment takes the linear average of path losses between the user equipment and a serving base station and between the user equipment and at least one cooperative base station as a determined path loss;
b. indicating the path loss generation mode that the user equipment takes the minimum of the path losses between the user equipment and the serving base station and between the user equipment and the at least one cooperative base station as the determined path loss;
c. indicating the path loss generation mode that the user equipment takes the maximum of the path losses between the user equipment and the serving base station and between the user equipment and at least one cooperative base station as the determined path loss;
d. indicating the path loss generation mode that the user equipment takes the path loss between the user equipment and the serving base station as the determined path loss;
e. indicating the path loss generation mode that the user equipment takes the reciprocal of the sum of the reciprocal of the path loss between the user equipment and the serving base station and the reciprocal of the path loss between the user equipment and the at least one cooperative base station as the determined path loss; and
f. indicating the path loss generation mode that the user equipment takes a path loss between the user equipment and specified one of the at least one cooperative base station as the determined path loss.
